(19) United States
(12) Patent Application Publication
(10) Pub. No.: US 2007/0094432 A1
(43) Pub. Date: Apr. 26, 2007

(54) Request transmission mechanism and method thereof

(75) Inventors: Te-ling Ping, Gueishan Township (TW); Ming-hsien Lee, Hsinchu City (TW); Tsan-hwi Chen, Hsinchu City (TW); Chun-cheng Chen, Hsinch City (TW)

Correspondence Address: TROXELL LAW OFFICE PLLC, SUITE 1404, 5205 LEESBURG PIKE, FALLS CHURCH, VA, 22041, US

(73) Assignee: Silicon Integrated Systems Corp.

(21) Appl. No.: 11/256,081

(22) Filed: Oct. 24, 2005

(51) Int. Cl. G06F 13/14

(52) U.S. Cl. 710/240

(57) ABSTRACT

The present invention discloses a request transmission mechanism and a method thereof capable of reducing request transmission time. The method and mechanism in accordance with the present invention allow a request to bypass unnecessary stages in a computer system by usage of a bypassing rule and a dependence controller. The dependence controller comprises a comparator capable of receiving the instruction from the dependence controller and enabling a designated bypassing path if the request is allowed to bypass. A plurality of dependence lines are connected to the dependence controller for indicating a dependent status between at least two requests. The request may be allowed to bypass a stage even though the buffer of the stage is not empty. The method and mechanism of the present invention is capable of reducing the request transmission time by determining the dependence between the requests.

### FIELD OF THE INVENTION

The present invention generally relates to a request transmission mechanism and a method thereof, especially a mechanism and method capable of allowing requests to bypass unnecessary stages in a computer system.

### BACKGROUND OF THE INVENTION

As known, “Latency” is one of the most important performance indicators for a computerized system. The more and more idle time when several requests stay in corresponding stages (or queues) of the computerized system will expedite a longer latency. In conventional request transmission procedure, the requests must be processed in sequence of stages such as a memory for a quite long idle time since the requests are standby in a buffer of each of the fixed stages. Accordingly, the present invention proposes a mechanism and a method for performing the same, with a bypassing technology to minimize the waiting time of the requests during idled in the buffer of the stages.

In order to reduce the latency of the computer system, a determining rule for distinguishing whether a request can be routed into a predetermined path is necessary for improving the system performance. As a data reordering mechanism of a computer system disclosed in U.S. Pat. No. 6,665,794, the data reordering mechanism can change the data ordering of a data packet from the processor cache into a predetermined ordering according to their address in the processor cache. The predetermined ordering is maintained independent of the output ordering from the processor bus and the addresses of a received x86 ordered cycle is aligned to the address of the first data unit (e.g., qword) in the predetermined ordering. Hence, if the address of only one of the qwords in a packet is known, the addresses of other qword can be determined based on the ordering in the packet.

Another method and system for bypassing memory controller components disclosed in U.S. Pat. No. 6,745,308, the memory controller analyzes internal component to determine if any pending memory requests exist. If one or more specific memory controller components are idle, a memory client is informed that a bypassing of memory controller components is possible. The memory controller comprises a bypass module for receiving memory requests from the memory client and examining memory controller parameters and a configuration of main memory to determine which memory controller components may be bypasses and routes the memory request accordingly.

The conventional reordering mechanism of the computer system has to check the address information in order to determine the priority of a data packet. This reordering mechanism is suitable for a data which can be separated as into several packets, but the reordering mechanism can not used for a data which can not be separated, e.g., a memory accessing request. The conventional bypass module of the memory controller determines a request can be skipped a specific memory request queue if the memory request queue is empty. When the memory request queue is not empty, in other words, there is any else request in the memory request queue, the request can not be allowed to bypass even if the requests have no any dependence with each other. Therefore, it is necessary to provide a method and a mechanism to overcome the disadvantages of conventional arts.

### SUMMARY OF THE INVENTION

A primary object of the present invention is to provide a request transmission mechanism and a method thereof capable of reducing request transmission time, which can allow the requests to bypass unnecessary stages in a computer system.

A second object of the present invention is to provide a request transmission mechanism and a method thereof capable of reducing request transmission time, which can allow the requests to bypass unnecessary stages in a computer system according to a bypassing rule.

A further object of the present invention is to provide a request transmission mechanism capable of reducing request transmission time, which can allow the requests to bypass unnecessary stages in a computer system by a dependence controller.

According above objects of the present invention, there is provided a method and a mechanism, with usage of a bypassing rule and a dependence controller, to allow a request to bypass unnecessary stages in a computer system, thereby reducing each request transmission time. A plurality of dependence lines are connected to the dependence controller for indicating a dependent status between at least two requests. The dependence controller comprises a comparator capable of receiving the instruction from the dependence controller and enabling a designated bypassing path if the request is allowed to bypass. The method and mechanism in accordance with the present invention can be implemented within a chipset of a computer system, such as a north/or a south bridge chip. Such a chipset will be capable of simultaneously processing more requests than conventional chipsets because the average time of processing each request is diminished more. Accordingly, the execution performance of the chipset can be improved.

In contrast to the prior art, the method and mechanism of the present invention is capable of allowing a request to bypass one or more stages if the request doesn't depend on any request in these stages. The request may be allowed to bypass a stage even though the buffer of the stage is not empty. The method and mechanism of the present invention is capable of reducing the request transmission time by determining the dependence between the requests.

Other objects, advantages and novel features of the invention will become more apparent from the following detailed description when taken in conjunction with the accompanying drawings.

### BRIEF DESCRIPTION OF THE DRAWINGS

The present invention will be apparent to those skilled in the art by reading the following description of preferred embodiments thereof, with reference to the attached drawings, in which:

FIG. 1 is a block diagram illustrating an example of a simplified computer system;

FIG. 2 is a block diagram illustrating an example of a request proceeding in corresponding stages;

FIG. 3 is a schematic diagram illustrating the stages with the dependence tags and dependence tag lines;

FIG. 4 is a schematic diagram illustrating a dependence controller for determining which one and how many of stages can be bypassed; and

FIG. 5 is a flowchart illustrating the bypass rule of the dependence controller.

### DETAILED DESCRIPTION OF THE PREFERRED EMBODIMENTS

The present invention will now be described more specifically with reference to the following embodiments. It is to be noted that the following description of the preferred embodiments of the present invention are presented herein for purpose of illustration and description only and it is not intended to be exhaustive or to be limited to the precise form disclosed.

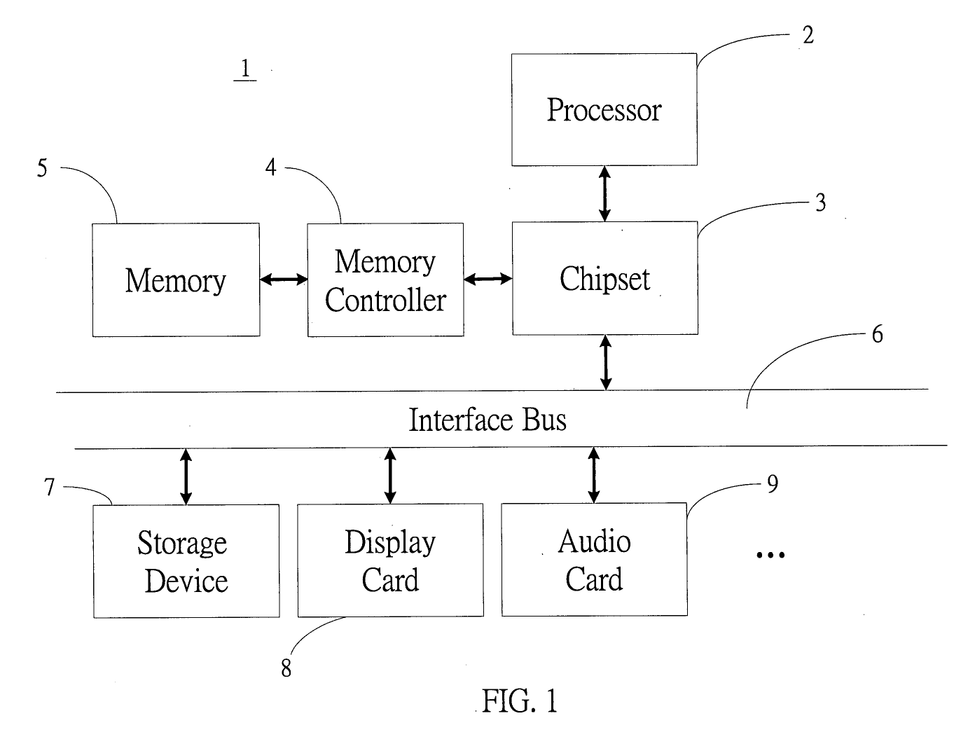

A simplified computer system 1 is illustrated in FIG. 1. The computer system 1 includes a processor 2, a chipset 3, a memory controller 4, a memory 5, an interface bus 6 and a plurality of peripheral devices. The processor 2 is utilized to execute the requests in the computer system 1. The chipset 3 is capable of bridging the communication between processor 2 and other devices, such as the memory controller 4 and interface bus 6. The memory controller 4 accesses the memory 5 for storing or acquiring data according to the requests from the chipset 3. The interface bus 6 can be a Peripheral Component Interconnect bus (PCI bus), an Integrated Drive Electronics bus (IDE bus), an Accelerated Graphic Port bus (AGP bus) or any other interface bus in a computer system. The peripheral devices can be a storage device 7, a display card 8, an audio card 9 or any other device complied with a protocol of the interface bus 6.

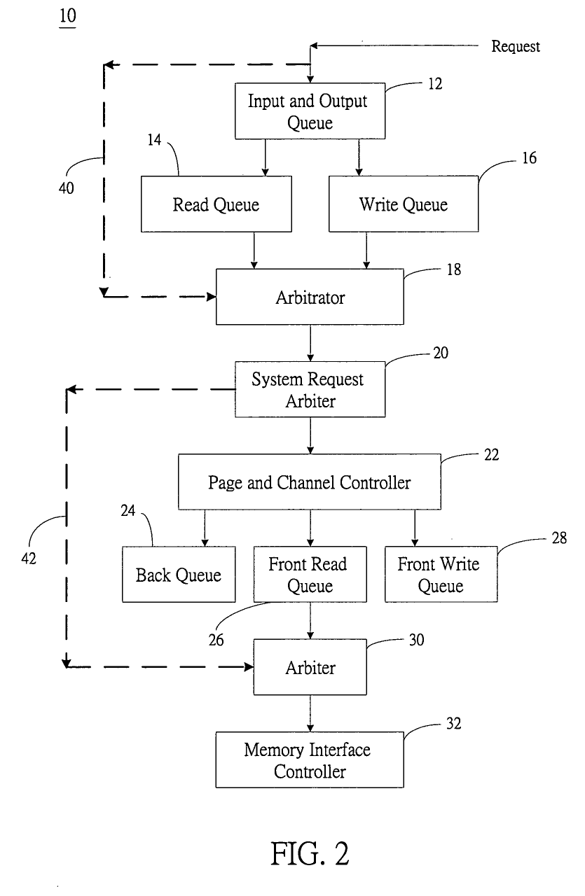

Please refer to FIG.1 and FIG. 2, a request transmission mechanism 10 is presented for implementing a specific bypass rule to reduce the latency during the request transmission between corresponding stages (or queues) in the memory controller 4. Each block shown in FIG. 2 represents a specific stage of the request transmission mechanism 10 for processing corresponding request. For examples, an input and output queue 12 is capable of buffering the requests from an input and output interface( not shown). Read and write queues 14, 16 are capable of buffering the read and write requests from the input and output queue 12, respectively. Arbitrator 18 is used to arbitrate the requests from the read or write queues 14 or 16 to the appropriate stages. System request arbiter 20 is utilized to arbitrate the requests from the arbitrator 18. Page and channel controller 22 is capable of dispatching the requests according to corresponding pages or channels thereof. Back queue 24 is a buffer place for transferring the requests from the Page and channel controller 22. Front read queue 26 and front write queue 28 are used to buffer the read and write requests respectively for different clock domains. Arbiter 30 is used to arbitrate the requests from back queue 24, front read queue 26 and front write queue 28 to a memory interface controller 32 and the memory interface controller 32 is utilized to transfer the requests to a memory (not shown). Besides, each stage must be capable of transferring the format of the request to the format of the next target stage which the request will be transmitted to.

Two broken lines 40, 42 indicate bypassing paths, which allow the specific requests to bypass specific unnecessary stages. The broken lines 40, 42 guide the specific requests to bypass unnecessary stages, according to a predetermined rule and path for timesaving when the specific requests stay in each stage. For example, a request can be forthrightly transmitted from the system request arbiter 20 to the arbiter 30 if the request does not necessarily pass through the intermediate stages.

The dependence between different requests determines whether the specific request can be allowed to bypass unnecessary stage. The bypassing rule according to the present invention is based on the dependence of the requests. A simplified example of requests in a calculation flow which includes a plurality of requests can be used to explain the dependence of the requests. The example of the requests in the calculation flow include following requests:

request_1: Load Reg1, [1000]

request_2: Load Reg2, [1004]

request_3: Load Reg3, [1008]

request_4: Load Reg4, [1000]

request_5: Add Reg5, Reg3, Reg4

request_6: Store [1012], Reg5

request_7: Sub Reg6, Reg5, Reg4

request_8: Mul Reg7, Reg6, Reg3

request_9: Store [1000], Reg7

request_10: Load Reg7, [1000]

The request_1 and the likes are purposed to load a registered value, such as Reg1, from a designated address in memory, such as [1000]. The request_6 and the likes are purposed to store a registered value, such as Reg5, to a designated address in memory, such as [1012]. The request_5, request_7 and request_8 are the arithmetic requests for calculating corresponding registered values. The request_5 are purposed to add the registered values, such as Reg3 and Reg4, to produce another registered value, such as Reg5. The request_7 are purposed to subtract the Reg5 from the Reg4, to produce another registered value Reg6. The request_8 are purposed to multiply the Reg3 and Reg6 to produce another registered value Reg7.

According to above example, for instance, the request_2 is independent from the request_1 because of that the memory source of the request_1 is irrelative to the request_2. In other words, there is no dependence between the request_2 and request_1 in point of view of the data path. Further refer to FIG. 2. In case of that the request_1 is stay in the buffer of the input and output queue 12 and the buffers of the read and write queues 14, 16 are empty, the request_2 can be allowed to bypass the input and output queue 12, read queue 14 and write queue 16 and be forthrightly transmitted to the arbitrator 18 according to the predetermined bypassing path of the broken line 40. Contrarily, for example, the request_6 is dependent on the request_3 and request_4 because of that the processing results of the request_3 and request_4 will affect the result of the request_6. In case of that one of the request_3 and request_4 is stay in the buffer of one of the input and output queue 12, read queue 14 or write queues 16, the request_6 can not bypass the input and output queue 12, read queue 14 and write queue 16. Similarly, the dependence between other requests can be determined according to the substantially identical spirit of the bypassing rule in accordance with the present invention.

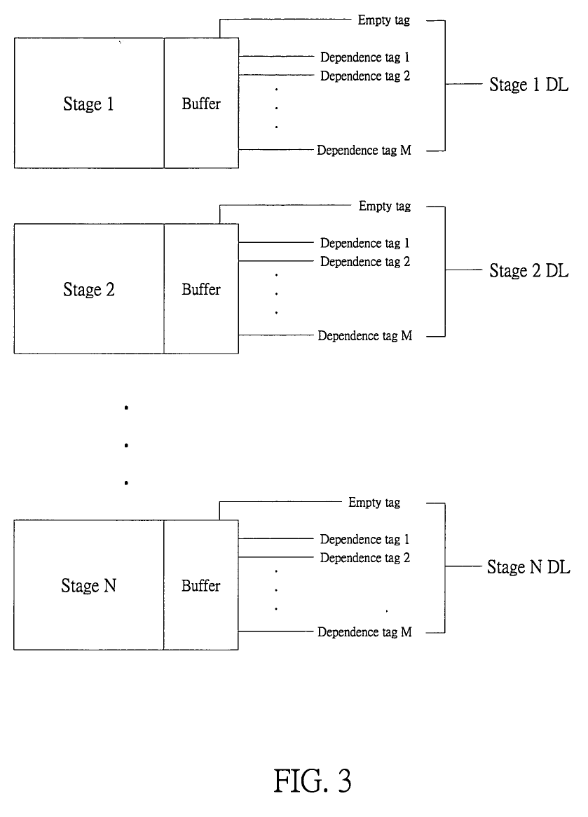

Please refer to FIG. 3. FIG. 3 illustrates the stages with the dependence tags and dependence tag lines. Each stage includes a buffer, an empty tag and a plurality of dependence tags. The buffers are used to temporarily store the request which the stage will process. The empty tag and the dependence tags of one stage are associated to form a dependence tag line. The stages 1 to stage N are the stages which can be bypassed by the specific requests according to the bypassing rule and path. Each stage comprises an empty tag and a plurality of dependence tags from 1 to M wherein M is an integer for indicating the total types of the specific requests that can be allowed to bypass at least a corresponding stage. It should be noted that the total types of the specific requests can be determined by the designer according to the features and requirement of the product. For example, the request types can be defined as different Unit IDs from different sources or to different destinations and thus means dependence free. The empty tag and the dependence tags of each stage are associated to form a dependence line, such as stage 1 DL, stage 2 DL, . . . , stage N DL wherein N is an integer for indicating the total numbers of the specific stages which may allow the specific request being bypassed. The empty tag is used to indicate whether the buffer of the corresponding stage is empty. Each dependence tag is used to indicate the dependence between the specific request stored in the buffer of the stage and other request in the buffer of the other stage if the buffer of the stage is not empty. For example, if a latter request in the buffer of the stage 1 is dependent on a former request in the buffer of the stage 2, the dependence tag 1 of the stage 2 indicates a dependent status for inhibiting the latter request to bypass the stage 2, else the dependence tag 1 indicates a non-dependent status for allowing the latter request to bypass the stage 2 wherein the dependent status can be represented by a signal of “0” and non-dependent status can be represented by a signal of “1”.

It should be noted that a request in any stage can be allowed to bypass any further stages. The total types of the specific requests may depend on the possibility which the bypass may be generated for optimizing the cost and the performance of the chip.

Thus, the specific request which may be allowed to bypass a stage can bypass the stage while the empty tag of the stage indicates an empty status or the dependence tag corresponding to the stage indicates a non-dependence status. Contrarily, the specific request can't bypass the stage while the dependence tag corresponding to the stage indicates a dependent status.

Each dependence line of the stage, such as stage 1 DL, stage 2 DL, . . . , stage N DL, comprises the empty tag and the dependence tags for indicating whether the specific request in the stage is dependent on another request in the other stage. In other words, the dependence line of each stage carry the information for determining whether the specific request in the stage is allowed to bypass which stage or stages.

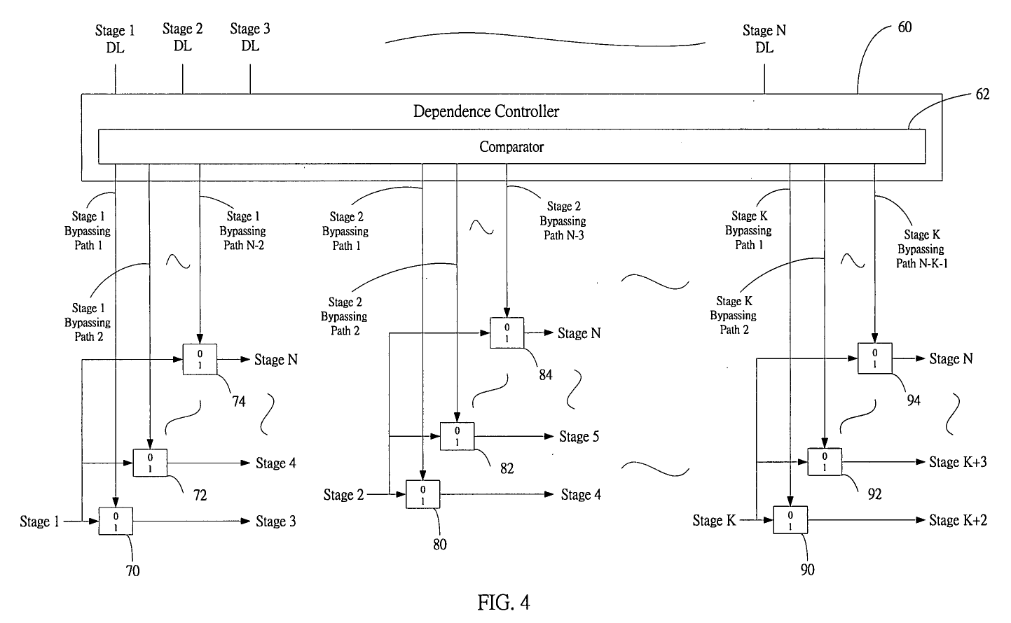

Please refer to FIG. 4. The dependence lines stage 1 DL, stage 2 DL, . . . , stage N DL are connected to a dependence controller 60. The dependence controller 60 determines which bypassing path should be enabled for transmitting a specific request from a stage to another stage in accordance with the bypassing information carried on each dependence line. The dependence controller 60 includes a comparator 62 capable of receiving the instruction from the dependence controller 60 and enabling a designated bypassing path if the request is allowed to bypass. For example, the comparator 62 enables a stage 1 bypassing path 1 for transmitting a specific request from stage 1 to stage 3 if the specific request is allowed to bypass. The stage 1 bypassing path 1 allows the specific request can be bypassed one stage, i.e. stage 2. Similarly, the comparator 62 enables a stage 1 bypassing path 2 for transmitting a specific request from stage 1 to stage 4 if the specific request is allowed to bypass. The stage 1 bypassing path 2 allows the specific request can be bypassed two stages, i.e. stage 2 and stage 3. Likewise, the comparator 62 enables a stage 1 bypassing path N-2 for transmitting a specific request from stage 1 to stage N if the specific request is allowed to bypass. The stage 1 bypassing path N-2 allows the specific request can be bypassed N-2 stages, i.e. stage 2 to stage N-1. The comparator 62 further coordinates a plurality of switches, such as switches 70, 72 or 74 corresponding to stage 1, switches 80, 82 or 84 corresponding to stage 2 and switches 90, 92 or 94 corresponding to stage K wherein K is a positive integer which is smaller than N-1, in order to determine which bypassing path should be enabled when a specific request is allowed to bypass. For instance, the stage 1 bypassing path 1 is enabled if the switch 70 indicates an enabling state. The enabling state of the switches can be represented by a signal of “1” and the disabling state can be represented by a signal of “0”. Likewise, the switch 72 and 74 indicate the status of the stage 1 bypassing path 2 and N-2 respectively. Similarly, the switches 80, 82, 84, 90, 92, 94 indicate the status of the bypassing paths corresponding to the related stages respectively.

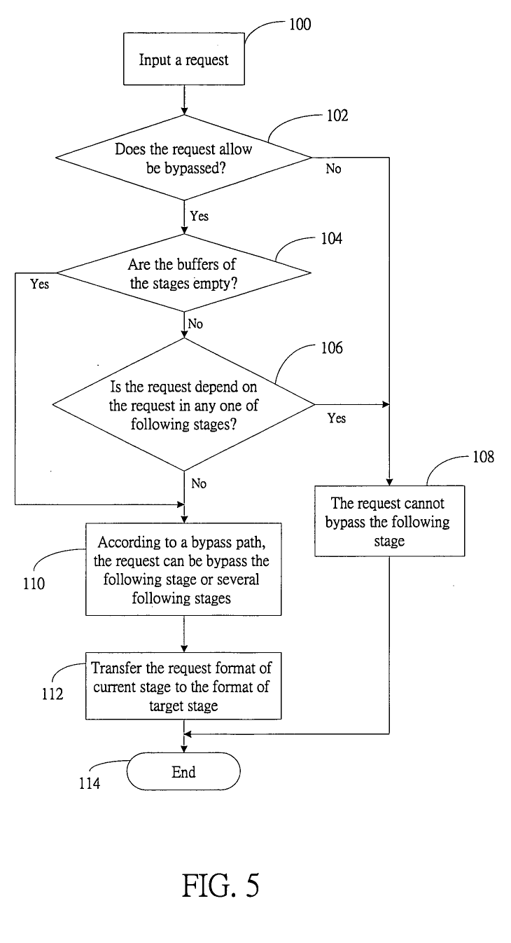

Please refer to FIG. 5. FIG. 5 shows a flowchart illustrating the bypass rule of the dependence controller according to the embodiment of the present invention. Each significant step of the flowchart are explained below:

100 Input a request.

102 Check whether to allow the request bypassing specific stages. If the request is allowed to bypass the specific stages, the procedure proceeds to step 104, else proceeds to step 108.

104 Check whether the buffers of the specific stages are all empty. If so, the procedure proceeds to step 110, else proceeds to step 106.

106 Check whether the request is dependent on any request that is being stayed in any buffer of the next specific stages. If so, the procedure proceeds to step 108, else proceeds to step 110.

108 The request can't bypass the specific stages and therefore is transmitted over original fixed stages.

110 The request can bypass the specific stage or stages, e.g. a part of the original fixed stages, according to a bypassing path.

112 Transfer the format of the request to the corresponding format of a target stage.

114 End.

In contrast to the prior art, the method and mechanism of the present invention is capable of allowing a request to bypass one or more stages if the request doesn't depend on any request in these stages. The request may be allowed to bypass a stage even though the buffer of the stage is not empty. The method and mechanism of the present invention is capable of reducing the request transmission time by determining the dependence between the requests.

The method and steps of the embodiment in accordance with the present invention can be implemented in a way of either solid circuit within a chip or the software, without departing from the spirit and scope of the present invention for any person skilled in the art.

What is claimed is:

1. A request transmission mechanism capable of reducing request transmission time, the request transmission mechanism comprising:
a plurality of stages for processing corresponding requests;
a plurality of buffers, each coupled to one corresponding stage, for temporarily storing the request;
a plurality of dependence line, each coupled to one corresponding buffer, for indicating the dependence status between at least two requests; and
a dependence controller for determining a bypassing path of the request, the dependence controller comprising a comparator capable of enabling a bypassing path of the request.

2. The request transmission mechanism as claimed in claim 1 wherein each dependence line comprises a plurality of dependence tags for indicating whether a specific request in one stage is dependent on another request in the other stage.

3. The request transmission mechanism as claimed in claim 2 wherein each dependence lines comprises an empty tag for indicating whether the buffer of the corresponding stage is empty.

4. The request transmission mechanism as claimed in claim 1 wherein the comparator further coordinates a plurality of switches, each switch is utilized to enable the specific bypassing path.

5. A method capable of reducing request transmission time, the method comprising the steps of:
Inputting a request from an input and output interface;
Determining a dependence status between the request and other request in any one of stages; and
Transmitting the request to a target stage for bypassing at least one unnecessary stage according a bypass path.

6. The method as claimed in claim 12, further comprising a step of determining if the request be allowed to bypass at least one specific stage before the step of determining the dependence status.

7. The method as claimed in claim 12, further comprising a step of checking buffer status of at least one stage before the step of determining the dependence status.

8. The method as claimed in claim 12, further comprising a step of transferring a request format to comply with a format of the target stage before the step of transmitting the request to the target stage.

9. The method as claimed in claim 12, further comprising a step of transferring a format of the request to comply with a format of the target stage after the step of transmitting the request to the target stage.

10. A computer system comprising a processor for executing requests, a chipset coupled to the processor, a memory and a memory controller capable of accessing the memory, the memory controller comprising a request transmission mechanism capable of reducing request transmission time in the computer system, said request transmission mechanism comprising:
a plurality of stages for processing corresponding requests;
a plurality of buffers, each coupled to one corresponding stage, for temporarily storing the request;
a plurality of dependence line, each coupled to one corresponding buffer, for indicating the dependence status between at least two requests; and
a dependence controller for determining a bypassing path of the request, the dependence controller comprising a comparator capable of enabling a bypassing path of the request.

11. The request transmission mechanism as claimed in claim 10 wherein each dependence line comprises a plurality of dependence tags for indicating whether a specific request in one stage is dependent on another request in the other stage.

12. The request transmission mechanism as claimed in claim 11 wherein each dependence lines comprises an empty tag for indicating whether the buffer of the corresponding stage is empty.

13. The request transmission mechanism as claimed in claim 10 wherein the comparator further coordinates a plurality of switches, each switch is utilized to enable the specific bypassing path.
